(19) United States
(12) Patent Application Publication
(10) Pub. No.: US 2014/0261015 A1
(43) Pub. Date: Sep. 18, 2014

(54) SMOKE GENERATION DEVICE

(71) Applicant: The Original Nutshell SmokeCage Corporation, Greenville, TX (US)

(72) Inventor: Anthony Francis Nelson, Greenville, TX (US)

(21) Appl. No.: 14/211,185

(22) Filed: Mar. 14, 2014

Related U.S. Application Data
(60) Provisional application No. 61/784,873, filed on Mar. 14, 2013.

(51) Int. Cl. A23B 4/052

(52) U.S. Cl. CPC A23B 4/052
USPC 99/467; 29/428

(57) ABSTRACT

A reusable perforated steel cylinder device with detachable lid that may be filled with pecan nutshells or other natural food-grade organic substances that become volatized through a pyrolitic action induced by heated air to create a flavoring smoke plume within a gas grill chamber that adsorbs onto target food items is disclosed. This design improves generation of flavoring smoke in a grill chamber due to its universal distribution of perforations, and cylindrical shape which allows the ease of smoke passage from any orientation, eases handling with standard barbecue utensils for adjustment and placement, allows rapid pyrolization initiation for improved performance and convenience at standard grill cooking temperatures, and has enhanced oxygen regulation properties through the design selection of the percentage of open surface area (at least 40%) of the assembly and allows rapid soak and drain of contents without loss.

### PRIORITY CLAIM TO RELATED APPLICATIONS

This patent application is a non-provisional application of U.S. patent application Ser. No. 61/784,873 filed on Mar. 14, 2013, the entire contents of which are incorporated herein by reference.

### FIELD OF THE INVENTION

The present invention relates generally to field of cooking, more particularly, to a smoke generation device.

### BACKGROUND OF THE INVENTION

Gas grilled foods are devoid of the smoke flavor elements provided by traditional wood or charcoal fueled cooking methods.

The typical gross deficiencies of other smoke generating devices used within the grill chamber are of three types: 1) an inferior physical shape (square/triangular/rectangle) design which limits ease of handling and reduces heat exchange to the primary (sole) side which faces the heat source; 2) deficiency in the lack of sufficient oxygen regulation to create an efficient and steady smoke plume, and/or 3) insufficient design consideration to allow user to rapidly soak and drain the smoke generator contents when desired.

### SUMMARY OF THE INVENTION

A reusable perforated steel cylinder device with detachable lid that may be filled with pecan nutshells or other natural food-grade organic substances that become volatized through a pyrolitic action induced by heated air to create a flavoring smoke plume within a gas grill chamber that adsorbs onto target food items is disclosed. This design improves generation of flavoring smoke in a grill chamber due to its universal distribution of perforations, and cylindrical shape which allows the ease of smoke passage from any orientation, eases handling with standard barbecue utensils for adjustment and placement, allows rapid pyrolization initiation for improved performance and convenience at standard grill cooking temperatures, and has enhanced oxygen regulation properties through the design selection of the percentage of open surface area (at least 40%) of the assembly and allows rapid soak and drain of contents without loss.

The present invention provides a smoke generation device that includes a body, a first end piece and a second end piece. The body has a generally circular cross section, a first end and a second end. A plurality of first perforations are within the body. The first end piece is attached to and enclosing the first end of the body. The second end piece is attached to and enclosing the second end of the body.

In addition, the present invention provides a smoke generation device that includes a body, a first end piece and a second end piece. The body has a substantially circular cross section, a first end, a second end and a length to width ratio of approximately 4 to 1. A plurality of uniformly distributed first perforations are within the body. The plurality of uniformly distributed first perforations comprise at least 40% of a surface area of the body. The first end piece is attached to and enclosing the first end of the body. The second end piece is attached to and enclosing the second end of the body. The first end piece, the second end piece or the first and second end pieces are detachable from the body.

Moreover, the present invention provides a method of manufacturing a smoke generation device by providing a first sheet of metal having a plurality of first perforations therein, a second sheet of metal and a third sheet of metal, forming the first sheet of metal into a body having a generally circular cross section, a first end and a second end, forming the second sheet of metal into a first end piece and attaching the first end piece to the first end of the body, and forming the third sheet of metal into a second end piece attaching the second end piece to the second end of the body. The first end piece, the second end piece or the first and second end pieces are detachable from the body.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a photograph of a smoke generation device in accordance with one embodiment of the present invention;

FIG. 2 is a photograph of a smoke generation device in accordance with another embodiment of the present invention; and

FIG. 3 is a photograph of a smoke generation device in use on a grill in accordance with one embodiment of the present invention.

### DETAILED DESCRIPTION OF THE INVENTION

As stated above, gas grilled foods are mostly devoid of the smoke flavor elements provided by traditional wood or charcoal fueled cooking methods. One embodiment of the present invention improves generation of a flavoring smoke plume in a grill chamber due to its universal circular perforations, together with its cylindrical shape, allowing ease of smoke passage from any orientation and ease of handling with standard barbecue utensils for adjustment and placement within the grill. Its 16 gauge steel construction allows rapid pyrolization initiation for convenience at standard grill surface cooking temperatures and has enhanced oxygen regulation properties through the design selection of a percentage of open surface area of forty percent (40%). It also allows rapid soak and drain of contents when desired.

The cylinder design efficiently converts latent grill chamber cooking heat into smoke flavor compounds through a passive pyrolitic action upon the cellulosic biomass contents. The generated smoke plume passes through the entire perforated surface area to allow adsorption onto the target food items.

The present invention differs from what currently exists. Current market offerings exhibit oblique edges which create concentrations of heat and reduce performance and offer only biased smoke plume egress. The present invention's steel cylinder design allows the rapid exchange of latent grill chamber cooking heat into a pyrolizing action upon the cylinder contents due to its steel composition, round shape, cross-sectional dimension, four-to-one ratio of length to width and 40% open area via uniformly distributed one-eighth inch circular perforations.

The present invention improves generation of a flavoring smoke plume in a grill chamber due to its universal circular perforations and a four-to-one ratio cylindrical shape which allows the ease of smoke plume passage from any orientation, eases handling with standard barbecue utensils for adjustment and placement, allows rapid pyrolization initiation for convenience at standard grill cooking temperatures, and has enhanced oxygen regulation properties through the design selection of the percentage of open surface area of forty percent (40%). A basic embodiment of the present invention includes a perforated metal cylinder (body) with one fixed end, and a perforated metal detachable end (lid/top).

Now referring to FIG. 1, a smoke generation device 100 in accordance one embodiment of the present invention is shown. The smoke generation device 100 includes a body 102, a first end piece 104 and a second end piece 106. The body 102 has a generally circular cross section (e.g., a circular cross section, a semi-circular cross section, an elliptical cross section, or a polygonal cross section having five or more sides, etc.), a first end 108 and a second end 110. A plurality of first perforations 112 (e.g., holes, openings or vents, etc.) are within the body 102. The first end piece 104 is attached to and enclosing the first end 108 of the body 102. As shown, the first end piece 104 is a removable lid. The second end piece 106 is attached to and enclosing the second end 110 of the body 102. As shown, the second end piece 106 is an end wall. As example of the smoke generation device 100 being used on a grill is shown in FIG. 3.

The first end piece 104, the second end piece 106 or the first and second end pieces (104 and 106) can be detachable from the body 102. The first and second end pieces (104 and 106) can be a lid, a cap, a cover, an end wall, or other suitable configurations. The first end piece 104, the second end piece 106 or the first and second end piece (104 and 106) may have a plurality of second perforations (e.g., holes, openings or vents, etc.). Alternatively, a door or a removable panel can be provided in the body 102.

One embodiment of the present invention preferably has the following characteristics: (1) the body 102 has a length to width ratio of approximately 4 to 1; (2) the plurality of first perforations 112 comprise at least 40% of a surface area of the body 102; and (3) the plurality of first perforations 112 are uniformly distributed on the body 102. For example, each first perforation 112 is approximately one-eighth inch in diameter, the plurality of first perforations 112 form a uniformly staggered pattern in which the plurality of first perforations 112 are separated from one another by approximately three sixteenth of an inch, and the body 102 is made of at least 16 gauge cold rolled steel.

Referring now to FIG. 2, a smoke generation device 200 in accordance one embodiment of the present invention is shown. The body 102 is made up of a first body section 102a having a first cross-sectional area, a second body section 102b having a second cross-sectional area less than the first cross-sectional area, and a portion of the second body section 102b slidably inserted within the first body section 102a such that a length of the body 102 is adjustable as shown by arrows 202.

Other features may include a partition 204 within the body that divides an interior of the body 102 into a first portion and a second portion. The location of the partition 204 within the body 102 can be adjustable. The partition 204 can also be removable. One or more handles can be attached to the body, the first end piece 104 or the second end piece 106. The body 102 can also be rotatably mounted on a base.

The assembly cylinder is entirely filled with the desired user-selected cellulosic biomass contents (i.e.; pecan nutshells, woodchips, etc.) and the assembly lid is pressed onto the open cylinder end and secured in place by friction. The assembly is then placed horizontally upon a gas grill rack cooking surface and the grill cover is closed. The grill is ignited and the heat level is adjusted/selected prior to cooking food items. During this normal grill heat-up cycle, the assembly is exposed to the latent heated air inside the grill chamber. The assembly allows passage of heated air through its perforations and transfers additional heat through the contact of the steel cylinder walls onto the cylinder contents thereby causing the pyrolysis of the contents which generates a flavoring smoke plume into the grill chamber. Food is then added to the grill chamber and cooked with intermittent operation of the grill lid to capture and direct the smoke to surround the food items and allow smoke adsorption on the target food items to the user's preference level.

The present invention can be fabricated in various lengths, such as 8, 10 or 12 inches, etc. The fabrication process for a 12 inch long device will now be described. The assembly is fabricated from four distinct elements: The first element consists of a 12.00 inch by 12.00 inch square sheet of 16 gauge cold rolled perforated plain steel of standard mill finish which yields the main cylinder body; the second, and third elements consist of matching 4.00 inch×4.00 inch square sheets of 16 gauge cold rolled perforated plain steel of standard mill finish which yield the bottom, and top cylinder ends. The fourth element consists of 0.75 inch×13.00 inch strip of 16 gauge cold rolled solid plain steel which yields the lid/top ring element.

The aspect features of the perforated 16 gauge sheet metal may consist of repeating one-eighth (0.125) inch circular hole perforations on three-sixteenth (0.1875) inch centers of a uniformly staggered pattern.

The finished cylinder (body) dimensions measure: 12.00 inch tall by 3.81 inch wide. The cylinder shape is rendered using a standard shop technique of slip rolling a 12.00 inch×12.00 inch sheared sheet of the perforated stock yielding a rolled cylinder-like element. The rolled sheet cylinder-like element is then longitudinally butt-welded along the newly formed seam.

Creation of a fixed cylinder end is through the use of a single 4.00 inch×4.00 inch square perforated sheet (of the same material as the cylinder) which is then arc-welded onto one end of the formed cylinder element. Protruding excess metal is then trimmed flush with the outer cylinder rim edge. Optionally, a gas plasma cut circle of the perforated sheet in the appropriate diameter may be substituted. The detachable (lid/top) end element is then formed by mating the lid ring strip element around the outside perimeter of the open cylinder end. The lid ring end is demarcated, trimmed and butt-welded along its minor seam to create a proper circumferential friction fit onto the outer cylinder wall. The lid ring is then centered upon, and affixed to, the remaining 4.00 inch×4.00 inch perforated square (or pre-cut circle) via arc-welds at the internal side of the ring-to-sheet interface. All protruding excess metal is trimmed flush with the lid ring outer edge.

This assembly design exhibits the minimum amount of elements and dimensional attributes necessary to achieve the results of continuous smoke plume generation within a gas grill chamber using dry cellulosic biomass contents. The assembly achieves multiple functional objectives within the scope of its design dimensions, material selection and construction.

The foregoing description of the apparatus and methods of the invention in described embodiments and variations, and the foregoing examples of processes for which the invention may be beneficially used, are intended to be illustrative and not for purposes of limitation. The invention is susceptible to still further variations and alternative embodiments within the full scope of the invention, recited in the following claims.

What is claimed is:

1. A smoke generation device comprising:
a body having a generally circular cross section, a first end and a second end;
a plurality of first perforations within the body;
a first end piece attached to and enclosing the first end of the body; and
a second end piece attached to and enclosing the second end of the body.

2. The smoke generation device as recited in claim 1, wherein the first end piece, the second end piece or the first and second end pieces are detachable from the body.

3. The smoke generation device as recited in claim 1, wherein the first and second end pieces comprise a lid, a cap, a cover or an end wall.

4. The smoke generation device as recited in claim 1, further comprising a plurality of second perforations, openings or vents within the first end piece, the second end piece or the first and second end pieces.

5. The smoke generation device as recited in claim 1, the generally circular cross section comprising a circular cross section, a semi-circular cross section, an elliptical cross section, or a polygonal cross section having five or more sides.

6. The smoke generation device as recited in claim 1, further comprising a door or a removable panel in the body.

7. The smoke generation device as recited in claim 1, the body having a length to width ratio of approximately 4 to 1.

8. The smoke generation device as recited in claim 1, the plurality of first perforations comprising at least 40% of a surface area of the body.

9. The smoke generation device as recited in claim 1, the plurality of first perforations are uniformly distributed on the body.

10. The smoke generation device as recited in claim 1, the plurality of first perforations comprising a plurality of first holes, openings or vents.

11. The smoke generation device as recited in claim 1, wherein:
each first perforation is approximately one-eighth inch in diameter;
the plurality of first perforations form a uniformly staggered pattern in which the plurality of first perforations are separated from one another by approximately three sixteenth of an inch; and
the body is made of at least 16 gauge cold rolled steel.

12. The smoke generation device as recited in claim 1, the body comprising:
a first body section having a first cross-sectional area;
a second body section having a second cross-sectional area less than the first cross-sectional area; and
a portion of the second body section slidably inserted within the first body section such that a length of the body is adjustable.

13. The smoke generation device as recited in claim 1, further comprising a partition within the body that divides an interior of the body into a first portion and a second portion.

14. The smoke generation device as recited in claim 13, wherein a location of the partition within the body is adjustable.

15. The smoke generation device as recited in claim 13, wherein the partition is removable.

16. The smoke generation device as recited in claim 1, further comprising one or more handles attached to the body, the first end piece or the second end piece.

17. The smoke generation device as recited in claim 1, further comprising:
a base; and
the body is rotatably mounted on the base.

18. A smoke generation device comprising:
a body having a substantially circular cross section, a first end, a second end and a length to width ratio of approximately 4 to 1;
a plurality of uniformly distributed first perforations within the body, the plurality of uniformly distributed first perforations comprising at least 40% of a surface area of the body;
a first end piece attached to and enclosing the first end of the body;
a second end piece attached to and enclosing the second end of the body; and
wherein the first end piece, the second end piece or the first and second end pieces are detachable from the body.

19. The smoke generation device as recited in claim 18, further comprising a plurality of second perforations, openings or vents within the first end piece, the second end piece or the first and second end pieces.

20. The smoke generation device as recited in claim 18, wherein:
each first perforation is approximately one-eighth inch in diameter;
the plurality of first perforations form a uniformly staggered pattern in which the plurality of first perforations are separated from one another by approximately three sixteenth of an inch; and
the body is made of at least 16 gauge cold rolled steel.

21. A method of manufacturing a smoke generation device comprising the steps of:
providing a first sheet of metal having a plurality of first perforations therein, a second sheet of metal and a third sheet of metal;
forming the first sheet of metal into a body having a generally circular cross section, a first end and a second end;
forming the second sheet of metal into a first end piece and attaching the first end piece to the first end of the body;
forming the third sheet of metal into a second end piece attaching the second end piece to the second end of the body; and
wherein the first end piece, the second end piece or the first and second end pieces are detachable from the body.

22. The method as recited in claim 21, wherein the step of forming the first sheet of metal into the body comprises the steps of:
rolling the first sheet of metal into the body having the generally circular cross section and two adjacent longitudinal edges; and
welding the two adjacent longitudinal edges together; and
trimming any protruding excess metal from the body.
